(19) United States
(12) Patent Application Publication
(10) Pub. No.: US 2008/0245878 A1
(43) Pub. Date: Oct. 9, 2008

(54) IC CARD

(76) Inventors: Shigemasa SHIOTA, Tokyo (JP); Shigeo Kurakata, Tokyo (JP); Shinsuke Asari, Tokyo (JP); Tetsuya Iida, Tokyo (JP); Shinichi Fukasawa, Tokyo (JP)

Correspondence Address: MILES & STOCKBRIDGE PC, 1751 PINNACLE DRIVE, SUITE 500, MCLEAN, VA, 22102-3833, US

(21) Appl. No.: 12/050,926

(22) Filed: Mar. 18, 2008

(30) Foreign Application Priority Data
Apr. 5, 2007 (JP) 2007-099287

(51) Int. Cl. G06K 19/067

(52) U.S. Cl. 235/492

(57) ABSTRACT

Disclosed is a semiconductor device including built-in interface circuits whose operations are selected in response to initialization operation from a host apparatus coupled thereto. In the semiconductor device, a first synchronous interface circuit and a second asynchronous interface circuit using differential signals, share the external terminals of the differential signals (the external differential signal terminals). For example, the semiconductor device adopts an MMC interface circuit as the first interface circuit and a USB interface circuit as the second interface circuit, while keeping the IC card interface function. The semiconductor device selects operations of the adopted interface circuits exclusively. One selection method is to enable an interface operation of the first interface circuit, upon detection of a plurality of edge changes in a clock input from an external clock terminal, which is for initializing the first interface circuit when power supply to the semiconductor device is started.

### CROSS-REFERENCE TO RELATED APPLICATIONS

The disclosure of Japanese Patent Application No. 2007-99287 filed on Apr. 5, 2007 including the specification, drawings and abstract is incorporated herein by reference in its entirety.

### BACKGROUND OF THE INVENTION

The present invention relates to a host interface technology of a semiconductor device (IC card), and in particular, to a technology effectively applicable to an IC card module such as plug-in UICC (Universal Integrated Circuit Card), USIM (Universal Subscriber Identity Module), or SIM (Subscriber Identity Module).

Patent document 1 (International Publication No. WO 01/84490) describes a multifunction memory card in which a memory card unit and an SIM card unit are provided in a card substrate of the MMC card (MultiMeidaCard) or SD card standard.

Patent document 2 (Japanese Unexamined Patent Publication No. Hei 10 (1998)-334205) describes an IC card configured to have an IC card microcomputer provided in a base card with contact terminals for accessing the IC card microcomputer formed therein, to which a flash memory and contact terminals for accessing the flash memory are added. The contact terminals for accessing the IC card microcomputer meet the ISO/IEC 7816-2 standard. The contact terminals for accessing the flash memory are based on a memory card standard such as a smart card standard.

Patent documents 3, 4 (Japanese Unexamined Patent Publication No. 2005-44366, Japanese Unexamined Patent Publication No. 2005-115947) describe a technology that has USB (Universal Serial Bus) and another interface, switching the interfaces by a power supply voltage.

Patent document 5 (Japanese Unexamined Patent Publication No. 2004-133843) describes an IC card including a contact interface, a non-contact interface, and a USB (Universal Serial Bus) interface so that they can be switched with each other.

Patent document 6 (Published Japanese Translation of a PCT Application No. 2004-515858) describes a technology for using terminals, which are not used in an IC card, as USB terminals.

Patent document 7 (Japanese Unexamined Patent Publication No. 2004-280817) describes a technology for detecting a USB mode or an ISO mode in a dual-mode smart card that can operate in the ISO and USB modes based on the ISO 7816 protocol, according to the logical value of the clock pin in a power on reset state.

### SUMMARY OF THE INVENTION

The present inventors have studied on partial sharing of card terminals by a plurality of interface circuits in a multifunction card, and on exclusive control of their interface operations. More specifically, the inventors found the following needs. That is, in order to add a USB interface and an MMC interface (or an SD card interface) to an IC card based on the ISO 7816 so that the USB interface and the MMC interface can be used while the IC card interface function is kept effective, it is necessary to share a part of the card terminals by the two interfaces and to control their operations to be enabled exclusively. The cited references have been found by search after the completion of the present invention. In all the references, when the interfaces are switched or initially selected, it is necessary to provide voltage signals to specific external terminals from the card host side, in a form different from that of typical interface protocols. Thus, according to the above teachings, the card host supporting the USB and MMC interfaces of the multifunction card should have an additional function to output such specific voltage signals.

One object of the present invention is to provide a semiconductor device that can select an operation of a built-in interface circuit in response to an initialization operation by a host apparatus coupled to the interface circuit.

Another object of the present invention is to provide a semiconductor device that can select an operation of a desired interface circuit of a plurality of interface circuits, from an existing host apparatus without changing the interface function of the host apparatus.

Still another object of the present invention is to provide a semiconductor device that can use both a USB interface and an MMC or SD card interface while keeping the IC card interface function, and can exclusively use the two interfaces sharing a part of external terminals.

The aforementioned and other objects and novel features of the present invention will become apparent from the description of the present specification and the accompanying drawings.

The following is a brief description of typical inventions of those disclosed herein.

That is, a semiconductor device includes a first synchronous interface circuit, and a second asynchronous interface circuit using differential signals. The two interface circuits share external terminals of the differential signals (the external differential signal terminals). For example, the semiconductor device adopts an MMC interface circuit as a first interface circuit and a USB interface circuit as a second interface circuit, while keeping the IC card interface function. The semiconductor device selects operations of the adopted interface circuits exclusively. One selection method is to enable an interface operation of the first interface circuit, upon detection of a plurality of edge changes in a clock input from an external clock terminal for initializing the first interface circuit when power supply to the semiconductor device is started. Another selection method is to enable the interface operation of the second interface circuit, upon detection of a second level supplied to a pair of the external differential signal terminals that were initialized to a first level in response to the start of power supply to the semiconductor. The coupling of the second interface circuit can be recognized from the outside, by changing one of the external differential signal terminals to the first level in response to the detection of the second level.

The following is a brief description of effects obtained by typical inventions disclosed herein.

That is, it is possible to select an operation of a built-in interface circuit in response to an initialization operation by a host apparatus connected to the interface circuit.

Further, it is possible to select an operation of a desired interface circuit of a plurality of interface circuits, from an existing host apparatus without changing the interface function of the host apparatus.

Still further, it is possible to use a USB interface and an MMC interface while the IC card interface function is kept effective, allowing exclusive use of the two interfaces sharing a part of external terminals.

### BRIEF DESCRIPTION OF THE DRAWINGS

FIG. 1 is a block diagram showing a portable communication terminal which is an example of a data processing system using a multifunction card to which the present invention is applied;

FIG. 2 is a diagram showing external terminals based on the ISO/IEC 7816-2 standard;

FIG. 3 is a diagram showing an example of external interface signals in ICCM, MMCIF, USBIF, respectively, and the assignment of external terminals corresponding to the external interface signals;

FIG. 4 is a block diagram showing an example of a coupling configuration between APP and an interface controller that performs selection control of the interfaces based on edge changes in CLK;

FIG. 5 is a block diagram showing an example of the configuration in which only MMCCNT is coupled to the interface controller;

FIG. 6 is a block diagram showing an example of the configuration in which only HUSBIF is coupled to the interface controller;

FIG. 7 is a block diagram showing an example of the configuration of a selection control circuit;

FIG. 8 is a flowchart showing an example of the flow of switching operation by a selection control circuit 32_A;

FIG. 9 is a block diagram showing an example of the configuration of a selection control circuit 32_B;

FIG. 10 is a block diagram showing an example of a coupling configuration of the APP and the interface controller that performs selection control of the interfaces based on changes in D+, D− at the time of VCC supply;

FIG. 11 is a diagram showing a method based on the USB interface standard in order to recognize a full-speed or high-speed USB device;

FIG. 12 is a diagram showing a method based on the USB interface standard in order to recognize a low-speed USB device;

FIG. 13 is a logic circuit diagram showing an example of the details of the interface controller;

FIG. 14 is a timing chart showing an example of the operation timing when the interface controller is installed in the APP;

FIG. 15 is a logic circuit diagram showing an example of the configuration of another selection control circuit in which latch circuits 60, 61 are added to the selection control circuit of FIG. 13;

FIG. 16 is a block diagram showing an example of the configuration of the interface controller that performs selection control of the interfaces based on the changes in CLK edge and in D+, D−;

FIG. 17 is a block diagram showing an example of the configuration of a selection control circuit 32_E that controls enabling/disabling of the MMCIF in the interface controller of FIG. 16;

FIG. 18 is a logic circuit diagram showing an example of the configuration of the selection control circuit 32_E that controls enabling/disabling of the USBIF in the interface controller of FIG. 16; and

FIG. 19 is a timing chart showing an example of the operation for inputting a command from a CMD signal line shown in FIG. 6.

### DETAILED DESCRIPTION OF THE PREFERRED EMBODIMENTS

1. The outline of typical embodiments of the invention disclosed in the present application will be briefly described below. In the summary of the typical embodiment, the reference numerals in the drawings are referred to in parenthesis, which only show the components included in the concepts of those designated by the reference numerals.

[1] According to a typical embodiment of the present invention, a semiconductor device includes a first interface circuit (30), a second interface circuit (31), and a selection control circuit (32 (32_A, 32_B). The first interface circuit receives a clock input (CLK) from a first external terminal (C6), and interfaces signals (DAT0, CMD) using second external terminals (C4, C8). The second interface circuit interfaces differential signals (D+, D−) using the second external terminals, without receiving a clock input from the outside. The selection control circuit enables an interface operation of the first interface circuit by a first instruction signal (ENBM), upon detection of a plurality of edge changes in the clock input from the first external terminal in order to initialize the first interface circuit after the start of power supply. With such a semiconductor device, it is possible to enable the operation of the first interface circuit, based on the initialization operation from the outside to initialize the first interface circuit, namely, the edge changes in the clock input from the first external terminal. When the first interface circuit is an MMC or SD card interface, it is possible to select the operation of the first interface circuit without the need to change the interface function of an existing host apparatus.

According to an aspect of the embodiment, the semiconductor device receives a command from the second external terminal when a plurality of second clocks are input to the first external terminal at the start of power supply. At this time, the number of the first clocks is a clock number before reaching the number of the second clocks.

According to another aspect of the embodiment, in response to the start of power supply, the selection control circuit initially disables the interface operation of the first interface circuit by the first instruction signal (ENBM), and initially enables the interface operation of the second interface circuit by a second instruction signal (ENBU). Upon detection of the edge changes in the clock input, the selection control circuit disables the interface operation of the second interface circuit by the second instruction signal, and enables the interface operation of the first interface circuit by the first instruction signal. This can facilitate the exclusive control for selecting operations of the first and second interface circuits.

According to still another aspect of the embodiment, the first interface circuit determines that the instruction state by the first instruction signal is a defined state at a predetermined timing after the start of power supply. When the defined state means “enable”, the first interface circuit outputs a first mask signal (MSKU) for fixing the state of the second instruction signal (ENBU) to a disable instruction state. The second interface circuit determines that the instruction state by the second instruction signal is a defined state at a predetermined timing after the start of power supply. When the defined state means “enable”, the second interface circuit outputs a second mask signal (MSKM) for fixing the state of the first instruction signal (ENBM) to a disable instruction state. This can prevent the disabled state of the interface circuits from being unstable, when the first external terminal for clock input is undesirably changed by noise after the definition of the exclusive control for the interface operations of the interface circuits.

At this time, when the interface operation of the first interface circuit is enabled, the first interface circuit may release the disable instruction state to the second instruction signal in response to reset instructions supplied to the second external terminals. Similarly, when the interface operation of the second interface circuit is enabled, the second interface circuit may release the disable instruction state to the first instruction signal in response to the reset instructions supplied to the second external terminals. This makes it possible to reset the exclusive operation instructions to the first and second interface circuits by supplying the reset instructions to the second external terminals from the host apparatus.

According to still another aspect of the embodiment, the semiconductor device further includes latch circuits (43, 44) for latching the detection result obtained by detecting the edge changes in the clock input. The latch circuits perform latch operation due to the disable instruction state to the second instruction signal by the first mask signal, or due to the disable instruction state to the first instruction signal by the second mask signal. This can prevent the defined state of the exclusive control for the interface operations of the interface circuits, from being undesirably changed by noise.

At this time, when the interface operations of the first and second interface circuits are enabled, the interface circuits initialize the latch circuits to a through state, in response to the reset instructions supplied to the second external terminals. This makes it possible to reset the exclusive operation instructions to the first and second interface circuits, by supplying the reset instructions to second external terminals from the host apparatus.

According to still another aspect of the embodiment, the semiconductor device further includes a memory controller (24) coupled to the first and second interface circuits through an internal bus, and a non-volatile memory (23) coupled to the memory controller. This makes the semiconductor device a single chip LSI for memory card, or a memory card or memory module with multi-chip configuration.

According to still another aspect of the embodiment, the semiconductor device includes a microcomputer coupled to third external terminals. More specifically, the first external terminal is defined as a clock terminal (CLK). The second external terminals are defined as a data terminal (DAT0) and a command terminal (CMD) when used in the interface operation by the first interface circuit, and defined as a non-inverted data terminal (D+) and an inverted data terminal (D−) when used in the interface operation by the second interface circuit. The third external terminals are defined as a reset terminal (RES), a clock terminal (CLKI_IC), and an input/output terminal (I/O). The first interface circuit is an MMC interface circuit or an SD card interface circuit, and the second interface circuit is a USB interface circuit. Such a configuration makes it possible to use both the USB interface and the MMC interface (or the SD card interface) while the IC card interface function is kept effective, allowing exclusive use of the two interfaces sharing a part of the external terminals.

[2] According to another embodiment of the invention, a semiconductor device includes a first interface circuit (30), second interface circuit (31), first high-resistance DC circuits (R1, R2), a selection control circuit (32 (32_C, 32_D)), and a second high-resistance DC circuit (R3). The first interface circuit receives a clock input from a first external terminal, and interfaces signals using a pair of second external terminals. The second interface circuit interfaces differential signals using the second external terminals without receiving a clock input from the outside. The first high-resistance DC circuits initialize the second external terminals to a first level, in response to the start of power supply. The selection control circuit enables the interface operation of the second interface circuit by the second instruction signal (ENBU) upon detection of a second level supplied to the initialized second external terminals. The second high-resistance DC circuit changes one of the second external terminals to the first level in response to the detection of the second level by the selection control circuit. Thus, the coupling of the second interface circuit can be recognized from the outside of the second external terminal. With the semiconductor device, the host apparatus detects the coupling of the semiconductor device in the following way. The host side terminals coupled to the second external terminals, are coupled to the second level through the high resistances. The coupled semiconductor device changes one of the second external terminals from the second level to the first level through the high resistance. Thus, the host apparatus detects the coupling of the semiconductor device. In this case, the semiconductor device detects that the second external terminal, which was initialized to the first level in response to the start of power supply, is switched to the second level from the host apparatus side. Upon recognition of the coupling with the host apparatus for the interface operation of the second interface circuit, the semiconductor device enables the interface operation of the second interface circuit. Then, the semiconductor device changes the other second external terminal to the first level, allowing the host apparatus to detect the coupling of the semiconductor device capable of interfacing with the second interface circuit. When the second interface circuit is the USB interface circuit, it is possible to select the operation of the second interface circuit without the need to change the interface function of the existing host apparatus.

According to an aspect of the embodiment, in response to the start of power supply, the selection control circuit initially disables the interface operation of the second interface circuit (31) by the second instruction signal (ENBU), and initially enables the interface operation of the first interface circuit (30) by the first instruction signal (ENBM). Upon detection of the second level, the selection control circuit disables the interface operation of the first interface circuit, and enables the interface operation of the second interface circuit. This can facilitate the exclusive control for selecting operations of the first and second interface circuits.

According to another aspect of the embodiment, the semiconductor device includes latch circuits (60, 61) for latching the detection result obtained by detecting the second level. The latch circuits perform latch operation due to the disable instruction state to the second instruction signal by the first mask signal, or due to the disable instruction state to the first instruction signal by the second mask signal. This can prevent the defined state of the exclusive control for the interface operations of the interface circuits, from being undesirably changed by noise.

At this time, when the interface operations of the first and second interface circuits are enabled, the interface circuits initialize the latch circuits to a through state, in response to the reset instructions supplied to the second external terminals. This makes it possible to reset the exclusive operation instructions to the first and second interface circuits by supplying the reset instructions to the second external terminals from the host apparatus.

[3] According to still another embodiment of the present invention, a semiconductor device includes a first interface circuit (30), second interface circuit (31), a first high-resistance DC circuit (R1), a selection control circuit (32 (32_E)), and a second high-resistance DC circuit (R2). The first interface circuit receives a clock input from a first external terminal, and interfaces signals using a pair of second external terminals. The second interface circuit interfaces differential signals using the second external terminals without receiving a clock input from the outside. The first high-resistance DC circuit initializes the second external terminals to the first level in response to the start of power supply. The selection control circuit enables the interface operation of the first interface circuit by a first instruction signal, upon detection of a plurality of edge changes in the clock input from the first external terminal in order to initialize the first interface circuit after the start of power supply. The selection control circuit enables the interface operation of the second interface circuit by a second instruction signal, upon detection of the second level supplied to the second external terminals that were initialized to the first level. The second high-resistance DC circuit changes one of the second external terminals to the first level in response to the detection of the second level by the selection control circuit. Thus, the coupling of the second interface circuit can be recognized from the outside of the second external terminal.

With such a semiconductor device, as described above, when the first interface circuit is based on the MMC or SD card, it is possible to select the operation of the first interface circuit without the need to change the interface function of the existing host apparatus based on the MMC or SD card. Further, when the second interface circuit is based on the USB, it is possible to select the operation of the second interface circuit without the need to change the interface function of the existing host apparatus based on the USB. The control of the operation selection of the first and second interface circuits is not completely exclusive. This means, for example, that in the case of a semiconductor device including first and second interface circuits in addition to a microcomputer such as an IC card microcomputer coupled to third external terminals, the semiconductor device can be used for interfacing with a host apparatus that is based only on an interface by the third external terminals, with no difficulty. At this time, the interface operation is disabled both in the first and second interface circuits, thereby preventing malfunction and reducing wasteful power consumption.

According to an aspect of the embodiment, the semiconductor circuit includes a first latch circuit (43A) for latching the detection result by obtaining the plurality of edge changes in the clock input, and a second latch circuit (60A) for latching the detection result obtained by detecting the second level. The first and second latch circuits perform latch operation due to a disable instruction state to a second instruction signal by the first mask signal, or due to a disable instruction state to a first instruction signal by the second mask signal. This can prevent the defined state of the exclusive control for the interface operations of the interface circuits, from being undesirably changed by noise.

At this time, when the interface operation of the first interface circuit is enabled, the first interface circuit initializes the first and second latch circuits to a through state, in response to reset instructions supplied to the second external terminals. Similarly, when the interface operation of the second interface circuit is enabled, the second interface circuit initializes the first and second latch circuits to a through state, in response to the reset instructions supplied to the second external terminals. This makes it possible to reset the exclusive operation instructions to the first and second interface circuits by supplying the reset instructions to second external terminals from the host apparatus.

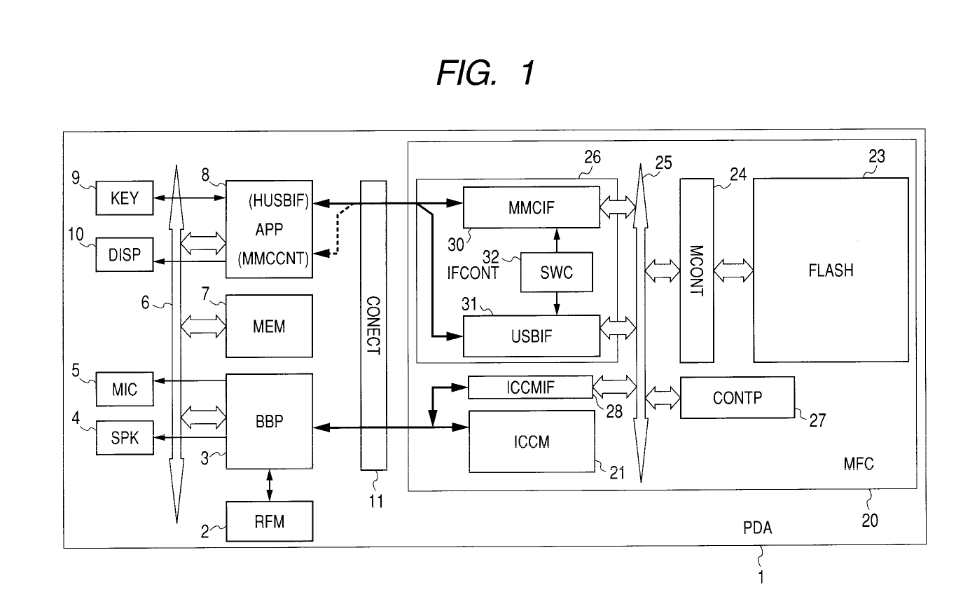

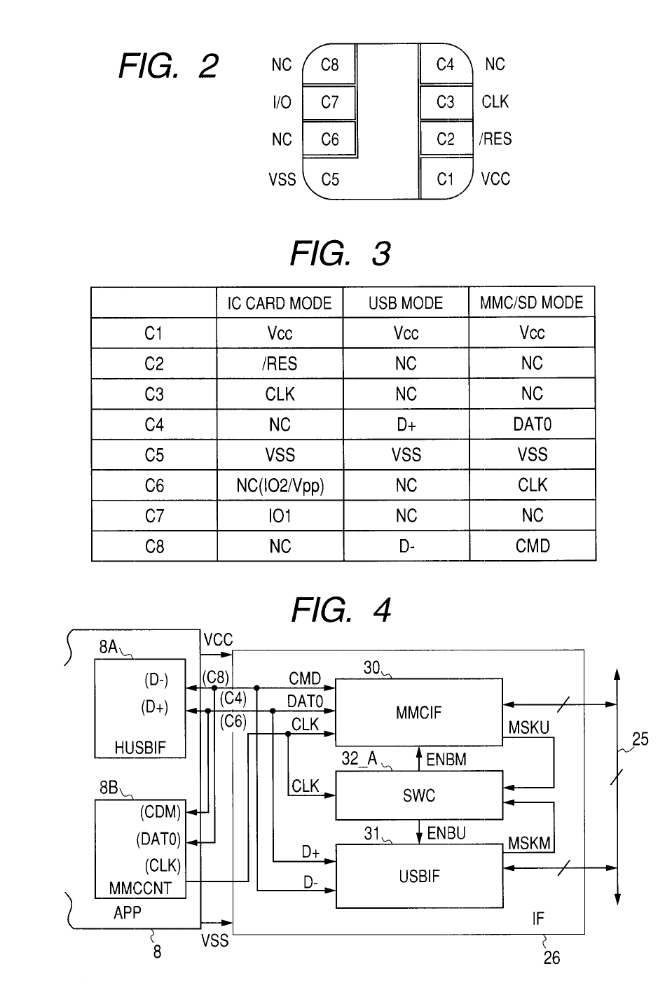

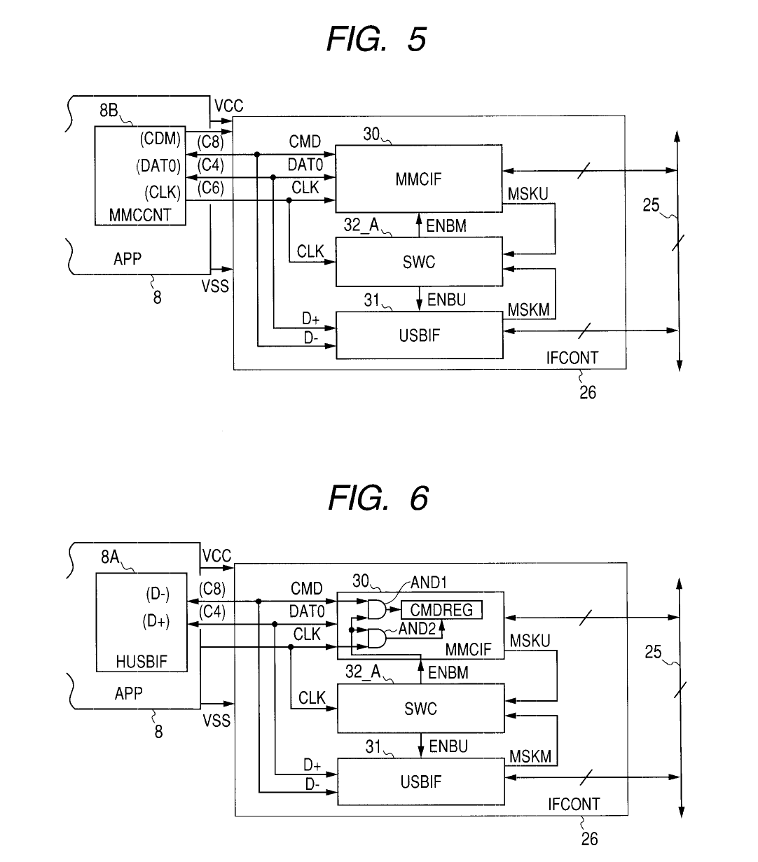

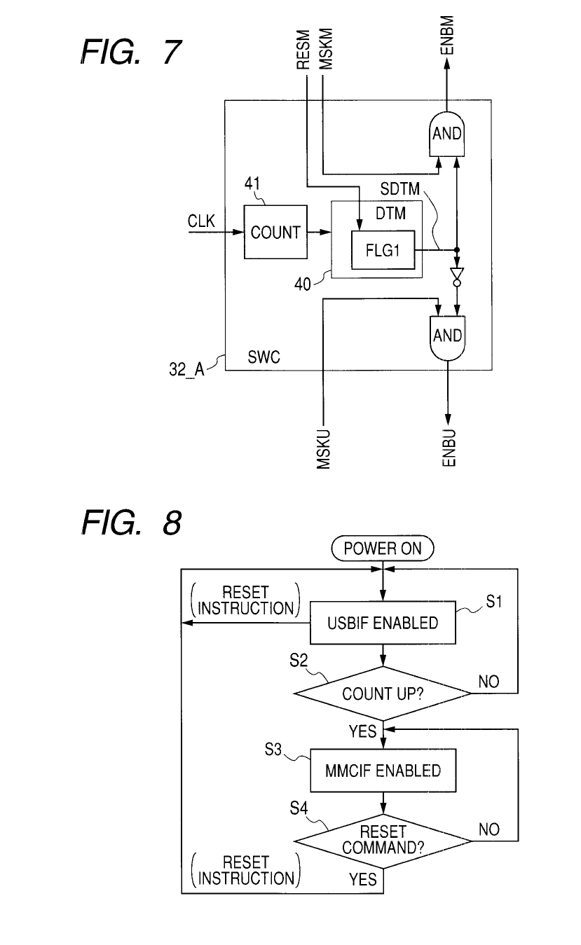

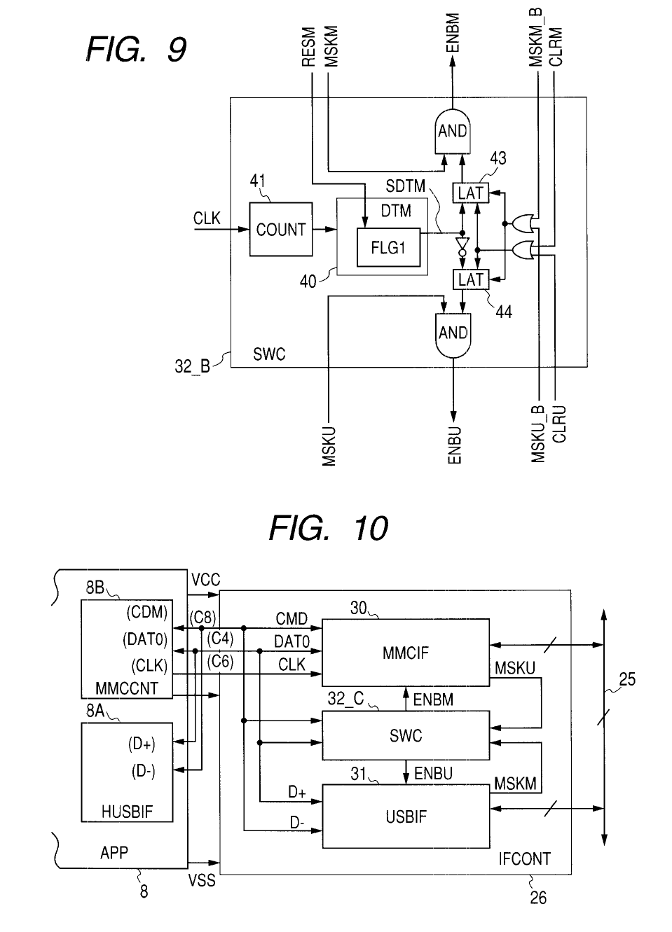

2. The Preferred Embodiments Will be Described Further in Detail Below.

<Portable Communication Terminal> FIG. 1 shows a portable communication terminal as an example of a data processing system to which the present invention is applied. The portable communication terminal includes such devices as mobile phones and PDAs (Personal Digital Assistants).

A portable communication terminal 1 includes a radio-frequency module (RFM) 2 to perform transmission/reception through an antenna at a predetermined frequency band. The radio-frequency module 2 performs frequency-up conversion of a baseband transmission signal supplied from a baseband processor (BBP) 3 as a baseband signal processing LSI. The radio-frequency module 2 also performs frequency-down conversion of an RF reception signal received by the antenna, to a reception baseband signal which is then supplied to the baseband processor 3. The baseband processor performs demodulation processing of the reception baseband signal, modulation processing of the transmission baseband signal, and protocol processing for mobile communications, and the like. A reception voice signal is supplied from the baseband processor 3 to a speaker (SPK) 4. A transmission voice signal is supplied from a microphone (MIC) 5 to the baseband processor 3.

The baseband processor 3 is coupled to a memory (MEM) 7 through a bus 6. The baseband processor 3 is also coupled to an application processor (APP) 8 serving as an accelerator for reducing the load of the baseband processor 3. The application processor 8 provides key scan for the key input from a keyboard (KEY) 9, as well as control of the display, and drawing of video and still images on a display (DISP) 10. The memory 7 is used in work areas of the baseband processor 3 and application processor 8, a frame buffer, a program area, and the like. The memory 7 is actually comprised of a non-volatile memory such as a flash memory, and of a random access memory such as a synchronous DRAM.

The portable communication terminal 1 is removably coupled to a multifunction card (MFC) 20, which can be used as an SIM card, through a connector (CONECT) 11. Although not so limited, the multifunction card 20 is used in a GSM (Group Special Mobile) communication system to store information, such as subscriber information and billing information, necessary to approve and manage the subscriber for security in mobile communications. In addition, the multifunction card 20 realizes an authentication protocol and a function as a removable storage. For the multifunction card 20, the baseband processor 3 and the application processor 8 are defined as a host computer. When the MFC 20 is inserted to a card socket of the portable communication terminal 1, a power voltage and a ground voltage are supplied to the MFC 20 from the host computer. In this way, the MFC 20 can start necessary initialization operations.

Preferably, the multifunction card 20 uses a product approved by the registration authority for ISO/IEC 15408 as an international standard for security evaluation. Generally, when an IC card having a function for security processing is actually used in electronic payment systems, the IC card should be evaluated and approved by the registration authority for ISO/IEC 15408. When a multifunction card is actually used in electronic payment systems, similarly to the SIM card, the multifunction card should be evaluated and approved by the registration authority for ISO/IEC 15408. In the present invention, the multifunction card includes a microcomputer (IC card microcomputer: ICCM) 21, which is an IC card chip approved by the registration authority, and performs security processing using the IC card microcomputer 21. Thus, the security processing function is obtained. With such a configuration, the multifunction card can easily meet the security evaluation standard based on ISO/IEC 15408. However, this does not mean to exclude installation of other IC card microcomputers not approved by the registration authority for ISO/IEC 15408. Any IC card may be used according to the security level of a service provided by the IC card microcomputer.

When the multifunction card 20 is assumed to be used as the SIM card, external terminals based on the ISO/IEC 7816-2 standard should be exposed from the card substrate. For example, as shown in FIG. 2, the multifunction card 20 includes external terminals C1 to C8. C1 is assigned to a power terminal (VCC), and C5 is assigned to a ground terminal (VSS). An input of reset signal (/RES) by C2, input of clock signal (CLK_IC) by C3, and input/output (I/O) of command/data by C7 are all assigned to an external contact interface of the IC card microcomputer 21. The remaining terminals C4, C6, C8 are free for the IC card microcomputer 21. As long as such specifications are met, there is no problem to install nonstandard terminals in addition to C1 to C8. The IC card microcomputer 21 performs security processing and the like, using the IC card command and data received from the terminal C7.

In addition to the IC card microcomputer 21, the multifunction card 20 includes, for example, the flash memory (FLASH) 23 to realize a large capacity storage. The multifunction card 20 further includes: a memory controller (MCONT) 24 for providing command control and the like to the flash memory 23; an interface controller (IFCONT) 26 coupled to the memory controller 24 through an internal bus 25; and a control processor (CONT) 27 coupled to the internal bus 25. The interface controller 26 is configured to be able to interface with the outside through the free terminals C4, C6, C8 that are not used for the outside interface by the IC card microcomputer. Although not so limited, the interface terminals C2, C3, C7 of the IC card microcomputer 21 are coupled to the internal bus 25 through an IC card microcomputer interface circuit (ICCMIF) 28. The IC card microcomputer interface circuit 28 receives an access command assigned to a free command code of the IC card command based on the ISO 7816, and issues a flash access command to the memory controller 24. In this way, the IC card microcomputer interface circuit 28 exchanges the access data with the memory controller 24. The control processor 27 controls the initial settings and the like, for the interface controller 26, the memory controller 24, and the IC card microcomputer interface circuit 28.

According to FIG. 1, the interface controller 26 includes: an MMC interface circuit (MMCIF) 30 as a first synchronous interface circuit; a USB interface circuit (USBIF) 31 as a second asynchronous interface circuit using differential signals; and a selection control circuit (SWC) 32. The MMC interface circuit 30 and the USB interface circuit 31 are both coupled to the internal bus 25.

FIG. 3 shows an example of external interface signals in the ICCM 21, MMCIGF 30, and USBIF 31, respectively, and the assignment of the external terminals corresponding to the external interface signals. The external interface signals of the ICCM 21 and the assignment of the external terminals have been described with reference to FIG. 2. The USBIF 31 interfaces with the outside by the differential signals D+, D−. The MMCIF 30 inputs/outputs the data DAT0 and outputs the command CMD, by synchronizing with the clock signal CLK. Of the terminals C4, C6, C8 that are not used by the ICCM 21, C6 is assigned to the input/output of the clock signal CLK. C4 and C8 are shared by the USBIF 31 and the MMCIF 30. Hence, C4 and C8 are assigned to the input/output of the differential signals D+, D−, as well as assigned to the input/output of the data DAT0 and to the output of the command CMD. The MMC interface is based on, for example, Multi Media Card System Specification Version 4.1 (February 2005 MMCA). The USB interface is based on, for example, Universal Serial Bus Specification Revision 2.0. The MMC interface is compatible with the SD card interface specifications, able to be replaced with the SD card interface. The SD card interface is based on, for example, SD Memory Card Specification Version 1.01.

The selection control circuit 32 selects and controls the availability of the interface operations of the MMCIF 30 and the USBIF 31, based on the states of the terminals C4, C6, and C8. The details of the selection control will be described below.

<Selection control of the interfaces based on the changes in CLK edge> FIG. 4 shows an example of a coupling configuration between the interface controller 26 and the APP 8. The interface controller 26 is coupled to the APP 8 through the terminals C4, C6, and C8. In this example, the APP 8 includes a USB interface circuit (HUSBIF) 8A and an MMC controller (MMCCNT) 8B. The HUSBIF 8A and the MMCCNT 8B are coupled to the interface controller 26 through the terminals C4, C6, and C8, respectively. The MMCIF 30 receives an input of the clock signal CLK from C6 defined as the first external terminal, and performs interface operation of DAT0 and CMD, using C4, C8 defined as the second external terminals. The USMBIF 31 performs interface operation of the differential signals D+, D− using the terminals C4 and C8, without receiving a clock input from the outside. As shown in FIG. 5, only the MMCCNT 8B may be coupled to the interface controller 26, or as shown in FIG. 6, only the HUSBIF 8A may be coupled to the interface controller 26.

The selection control circuit 32_A shown in FIGS. 4 to 6, selects and controls the availability of the interface operations of the MMCIF 30 and the USBIF 31, based on whether a plurality of edge changes can be detected in a clock input. The clock input is provided from the external terminal C6 to initialize the MMCIF 30 after the start of the supply of the power voltage VCC. ENBM is a selection signal for instructing “enable/disable” of the interface operation to the MMCIF 30, while ENBU is a selection signal for instructing “enable/disable” of the interface operation to the USBIF 31. Each of the selection signals indicates “enable” by a high level (the logical value “1”), and “disable” by a low level (the logical value “0”). MSKM is a mask signal for forcing the ENBM to the low level, while MSKU is a mask signal for forcing the ENBU to the low level.

FIG. 7 shows an example of the configuration of the selection control circuit 32_A. The selection control circuit 32_A includes a definition circuit (DTM) 40 of the MMCIF 30. The definition circuit 40 includes an enable flag FLG 1 that is initialized to a reset state (the logical value “0”) when the power voltage VCC and the ground voltage VSS are supplied to the MFC 20. The enable flag FLG 1 outputs a signal SDTM with the logical value “0” in the reset state. The enable signal ENBU is the logical product of an inverted signal of the signal SDTM and the mask signal MSKU. The enable signal ENBM is the logical product of the signal SDTM and the mask signal MSKM. Immediately after the power on, the mask signals MSKM, MSKU are initialized to an unmasked level (the logical value “1”). Thus, in the initial state immediately after the power on, “disable” of interface operation is initially instructed to the MMCIF 30 by the ENBM with the logical value “0”, while “enable” of interface operation is initially instructed to the USBIF 31 by the ENBU of the logical value “1”. A counter (COUNT) 41 calculates the clock signal CLK supplied from the terminal C6. The clock signal CLK is a synchronizing clock signal in the MMC interface operation. According to the MMC interface specifications, the recognition method of the MMC immediately after the power on, is defined as follows. A clock signal CLK of 74 clock cycles is input as a dummy clock after the power on, and then a specific MMC command is issued. Upon receiving the MMC command, the MMC performs a predetermined initialization operation such as an internal operation mode setting. When the first clock signal CLK is input after the power on, the counter calculates the clock signal CLK, and outputs a count up signal at the number of counts less than 74 counts. The enable flag FLG 1 is set by the count up signal, and inverts the signal SDTM to the logical value “1”. Due to the signal inversion, the ENBM is changed to the logical value “1”, and instructs the MMCIF 30 to enable the interface operation. The ENBU is changed to the logical value “0”, and instructs the USBIF 31 to disable the interface operation. In this way, the initialization operation of the MMCIF is started. On the other hand, when no clock signal CLK is input, the USBIF 31 remains enabled, so that the initialization operation for the USBIF 31 is possible from the APP 8.

Here, the count up signal is output in response to a clock at a count value less than 74. Thus, the selection control circuit 32_A can recognize the MMC interface operation before the initialization operation, and can start the subsequent operation, such as command input, quicker than the case in which the count up signal is output after the count value of 74.

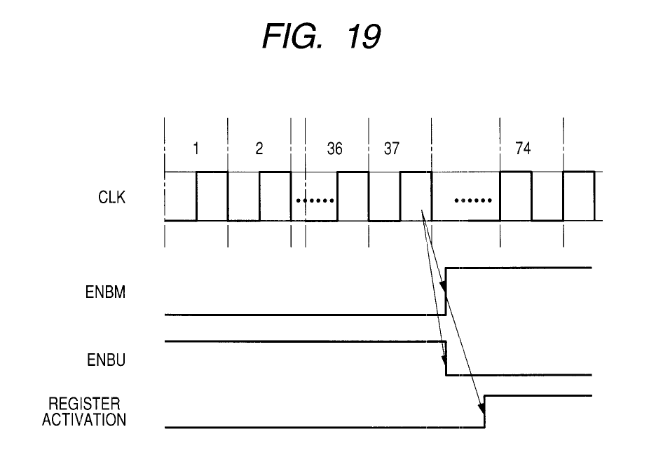

More specifically, as shown in FIG. 19, it is assumed that the MMC interface is determined in response to a clock at a count value of 37 which is a half of the count value of 74. The ENBM is activated while the ENBU is inactivated in response to the 37th clock.

When the ENBM is activated, as shown in FIG. 6, an MMC command resister CMDREG is activated through logic circuits AND 1, AND 2 in the MMCIF 30, allowing the command to be input from a CMD signal line. In this case, as shown in FIG. 19, the MMC command resister can be ready to be activated before the count value of the clock reaches 74.

It is to be noted that, here, a half of the count value of 74 is used as the clock number, but any clock number may be used as long as the number does not exceed 74. However, when the clock number is small, a problem of malfunction may arise due to noise. On the other hand, when the clock number is close to 74, the preparation time for the activation of the MMC command resister is reduced. For this reason, the clock value is preferably set to about one third or two thirds of 74. Further, the count value of the clock signal may be the number of edges of the clock waveform, or the number of top or bottom flat portions of the clock waveform.

Next, a description will be given of the selection control circuit 32_A that can control the interface operations exclusively to the MMCIF 30 and the USBIF 31.

The MMCIF 30 determines that the instruction state by the enable signal ENBM is a defined state, at a predetermined timing after the start of the supply of the power voltage VCC, for example, after the time for completing the initialization operation has passed. When the defined state means “enable”, the MMCIF 30 changes the mask signal MSKU to the mask instruction state with the logical value “0”. Similarly, the USBIF 31 determines that the instruction state by the enable signal ENBU is a defined state, at a predetermined timing after the start of the supply of the power voltage VCC, for example, when the time for completing the initialization operation has passed. When the defined state means “enable”, the USBIF 31 changes the mask signal MSKM to the mask state with the logical value “0”. Once the control of the interface operations exclusive to the USBIF 31 and the MMCIF 30 is defined, the state can be prevented from being unstable by noise.

The flag FLG 1 can be reset to a reset state by a signal RESM from the MMCIF 30. In the coupling configuration as shown in FIG. 4, when the APP 8 stops using the MMCIF 30 and switches to the USBIF 31, the APP 8 resets the flag FLG 1 by the MMC command at the end of the switching process, causing the enable signal ENBU to be active and the enable signal ENBM to be inactive. In this way, it is possible to switch to the interface operation of the USBIF 31. After that, when switching the interface operation back to the MMCIF 30, the APP 8 performs the initialization operation of the MMCIF 30 by inputting the clock signal CLK. In the switching operation, the MMCIF 30 inverts the mask signal MSKU to unmasked level (the logical value “1”) in response to the reset instruction, and releases the mask for the USBIF 31. On the other hand, when the USBIF 31 ends the interface operation in response to the reset instruction, the USBIF 31 inverts the mask MSKM to the unmasked level (the logical value “1”) to release the mask for the MMCIF 30. This makes it possible to reset the operation instructions exclusive to the MMCIF 30 and the USBIF 31, by supplying the reset instructions to the terminals C4, C8 from the APP 8.

FIG. 8 shows an example of the flow of the switching operation by the selection control circuit 32_A. The USBIF 31 is enabled by the power on (S1). Then, it is determined whether a count up performed by the counter 41 (S2). When the count up is performed, the MMCIF 30 is enabled (S3). When no count up is performed, the USBIF 31 remains enabled. The MMCIF 30 executes the MMC command from the APP 8, and when recognizes a reset command (S4, YES), initializes the flag FLG 1 and returns to Step S1. Similarly, the USBIF 31 is internally initialized upon receiving a reset instruction from a command packet from the APP 8.

Adoption of the selection control circuit 32_A facilitates the selection control of the interface operations exclusive to the MMCIF 30 and the USBIF 31. Further, the operation of the MMCIF 30 can be enabled, based on the initialization operation from the outside to initialize the MMCIF 30, namely, a plurality of edge changes in the clock input from the terminal C6. The interface operation of the MMCIF 30 of the MFC 20 can be selected without the need to change the standard interface function of the MMC controller (MMCCNT) of the APP 8.

FIG. 9 shows an example of the configuration of the selection control circuit 32_B. Unlike the selection control circuit 32_A of FIG. 7, the selection control circuit 32_B includes latch circuits (LATs) 43, 44. The latch circuit 43 receives the signal SDTM at a data input terminal, and the latch circuit 44 receives the inverted signal of the signal SDTM at a data input terminal. The latch circuits 43, 44 perform latch operation by a logical sum signal of an inverted signal of the mask signal MSKM, and an inverted signal of the mask signal MSKU. This can prevent the defined state of the selection control of the interface operations exclusive to the MMCIF 30 and the USBIF 31, from being undesirably changed by noise. The latch circuits 43, 44 are initialized to a through state by a logical sum signal of a clear signal CLRM output from the MMCIF 30 in response to the reset instruction from the APP 8, and a clear signal CLRU output from the USBIF 31 in response to the reset instruction from the APP 8. Adoption of the latch circuits 43, 44 ensures resetting of the exclusive operation instruction to the MMCIOF 30 and the USBIF 31 by the reset instruction from the APP 8.

<Selection control of the interfaces based on the changes in D+, D− at the time of VCC supply> FIG. 10 shows another example of the coupling configuration between the interface controller 26 and the APP 8. Unlike the configuration of FIG. 4, the terminals C4, C8 are coupled to the selection control circuit 32_C. The selection control circuit 32_C is a circuit to select and control the availability of the interface operations of the MMCIF 30 and the USBIF 31, based on the detection of voltage changes that appear in the terminals C4 (D+), C8 (D−) at the start of the supply of the power voltage VCC. At this time, the APP 8 recognizes the coupling/uncoupling of the USBIF 31.

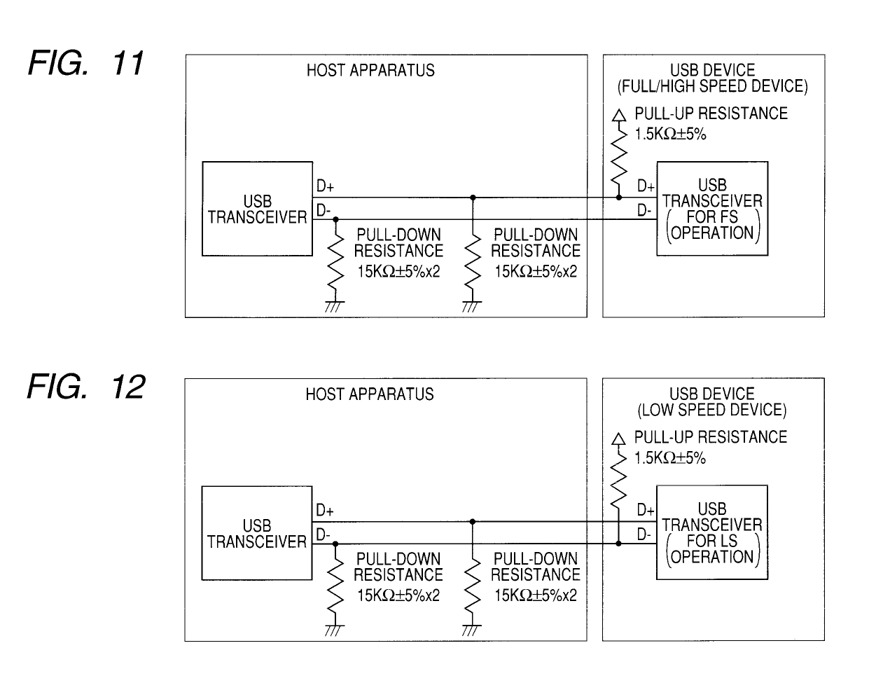

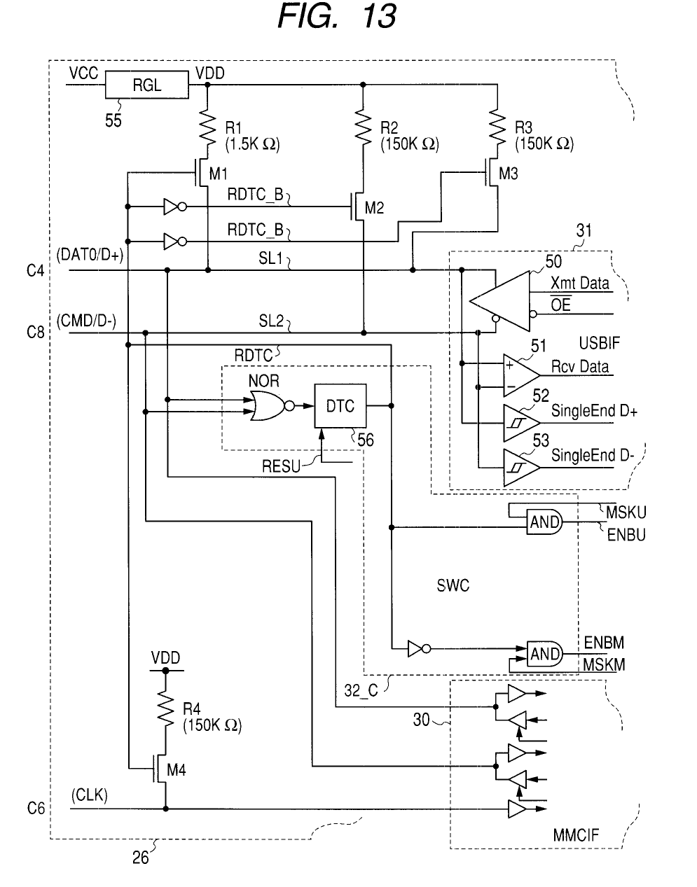

According to the USB interface standard, the coupling/uncoupling of the USB device is recognized by the host apparatus using circuit configurations shown in FIGS. 11 and 12. FIG. 11 shows a configuration for recognizing a full-speed or high-speed USB device. The host apparatus includes pull-down resistances of 15 k ohms that are coupled to a D+ signal line and a D− signal line, respectively. The USB device includes a pull-up resistance of 1.5 k ohms coupled to the D+ signal line. When the USB device is coupled to the host apparatus, the host apparatus recognizes the coupling of the USB device, by detecting that the D+ signal line is changed to a pull-up voltage from the ground voltage VSS. FIG. 12 shows a configuration for recognizing a low-speed USB device. Unlike the configuration of FIG. 11, the USB device includes a pull-up resistance of 1.5 k ohms coupled to the D− signal line. When the USB device is coupled to the host apparatus, the host apparatus recognizes the coupling of the USB device, by detecting that the D− signal line is changed to the pull-up voltage from the ground voltage VSS.

FIG. 13 shows an example of the details of the interface controller 26. The configuration shown in the figure is applied to a full-speed/high-speed USB interface. In the USBIF 31, reference numeral 50 denotes a differential transmission driver, reference numeral 51 denotes a differential receiver, and reference numerals 52 and 53 denote signal end receivers. One end of a pull-up resistance R1 of 1.5 k ohms is coupled to a signal line SL 1 that is coupled to the terminal C4 (DAT0, D+). The other end of the pull-up resistance R1 is coupled to an internal voltage VDD through a switch MOS transistor M1. Also, one end of a pull-up resistance R3 of 150 k ohms is coupled to the signal line SL 1, and the other end thereof is coupled to the internal voltage VDD through a switch MOS transistor M3. Further, one end of a pull-up resistance R2 of 1.5 k ohms is coupled to a signal line SL 2 that is coupled to the terminal C8 (CMD, D−). The other end of the pull-up resistance R2 is coupled to the internal voltage VDD through a switch MOS transistor M2. Still further, one end of a pull-up resistance R4 of 150 k ohms is coupled to a signal line that is coupled to the terminal C6 (CLK). The other end of the pull-up resistance R4 is coupled to the internal voltage VDD through a switch MOS transistor M4. The switch MOS transistors M1, M4 are switched under control of a detection signal RDTM. The switch MOS transistors M2, M3 are switched under control of an inverted signal of the detection signal RDTM. The internal voltage VDD is equal to the power voltage VCC reduced by a regulator (RGL) 55.

In the selection control circuit 32_C, a NOR gate receives inputs from the signal line SL 1 coupled to the terminal C4, and from the signal line SL 2 coupled to the terminal C8. A detection circuit (DTC) 56 receives an output of the NOR gate. A detection signal RDTC of the detection circuit 56 is initialized to the logical value “0” by the power on. The detection circuit 56 detects that the state of the low-level output of the NOR gate is stable. Then, the detection circuit 56 changes the detection signal RDTC from the logical value “0” to the logical value “1”, and maintains this state until the detection signal RDTC is reset by the signal RESU from the USBIF 31. In this way, the interface operation of the MMCIF 30 is initially enabled by the enable signal ENBM with the logical value “1”. The interface operation of the USBIF 31 is initially disabled by the enable signal ENBU with the logical value “0”. At first, when the power VCC is supplied, the MOS transistors M2, M3 are turned on by the detection signal RDTC with the logical value “0”. The signal lines SL 1, SL 2 are charged to the VDD level of the logical value “1”, by the pull-up resistances R2 and R3. When the terminals C4, C8 of the interface controller 26 are coupled to the APP 8, as described in FIG. 11, the signal lines SL 1, SL 2 are discharged by the pull-down resistances of 15 ohms within the APP 8. When the state of the logical value “0” is stable in the two lines, the detection signal RDTC is inverted to the logical value “1”. The signal line SL 1 is charged by the pull-up resistance R1 of 1.5 k ohms through the MOS transistor M1. In this way, the APP 8 can detect the coupling of the USBIF 31. At the same time, the enable signal ENBM is inverted to the low level, and the enable signal ENBU is inverted to the high level. Thus, the interface operation of the MMCIF 30 is disabled, and the interface operation of the USBIF 31 is enabled. In response to the disabling of the interface operation of the MMCIF 30, the input line of the clock signal CLK is charged by the resistance R4 to prevent an undesirable change in the clock terminal C6 due to noise. The functions of the mask signals MSKM, MSKU are the same as described in FIGS. 4 and 7, and the detailed description will be omitted.

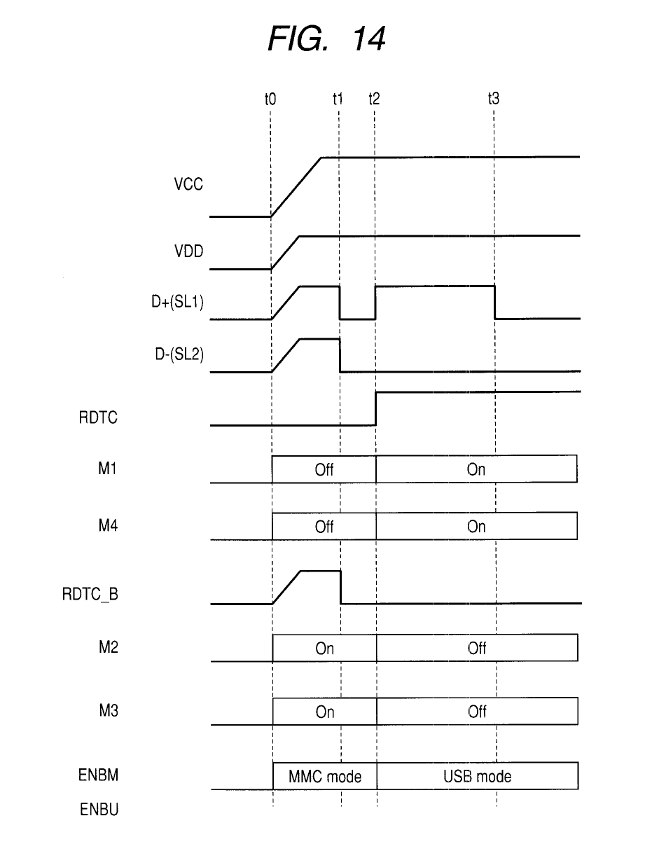

FIG. 14 shows an example of the operation timing when the interface controller 26 having the configuration of FIG. 13 is installed to the APP 8. When the interface controller 26 is brought into contact with the power terminal of the APP 8 (time to), the interface controller 26 is supplied with VCC, and an internal voltage VDD rises. In response to this, the signal lines SL 1, SL 2 are charged to the voltage VDD. At first, the interface operation of the MMCIF 30 is enabled, and the interface operation of the USBIF 31 is disabled. When the signal lines SL 1, SL 2 of the interface controller 26 are coupled to the terminals D+, D− of the APP 8 (time t1), the discharge of the signal lines SL 1, SL 2 is started. When the discharge level is stabilized (time t2), the detection signal RDTC is inverted to the logical value W “1” and maintained at this value. The MOS transistors M2, M3 are turned off, and the MOS transistors M1, M4 are turned on. Thus, the interface operation of the MMCIF 30 is changed to be disabled, and the interface operation of the USBIF 31 is changed to be enabled. At the same time, the signal line SL 2 is charged to the voltage VDD level through the pull-up resistance R1. In this way, the APP 8 can recognize the coupling of the USB interface circuit. Upon recognition of the coupling of the USB interface circuit, the APP 8 performs a bus reset (time t3), followed by a packet transmission in the NRZI (Non Return to Zero Invert) format through the signal lines D+, D−.

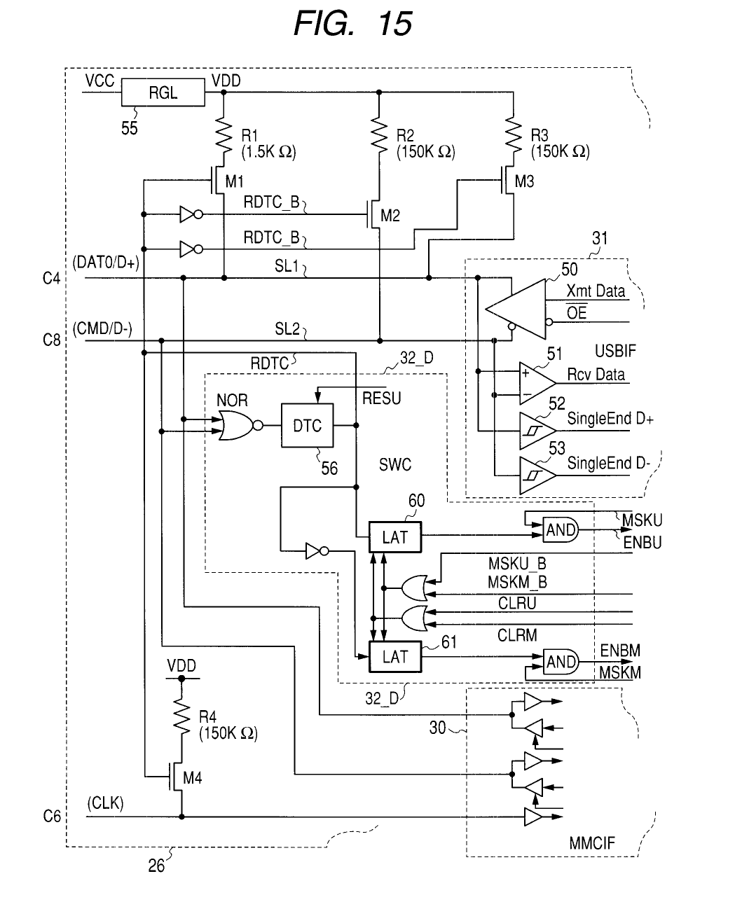

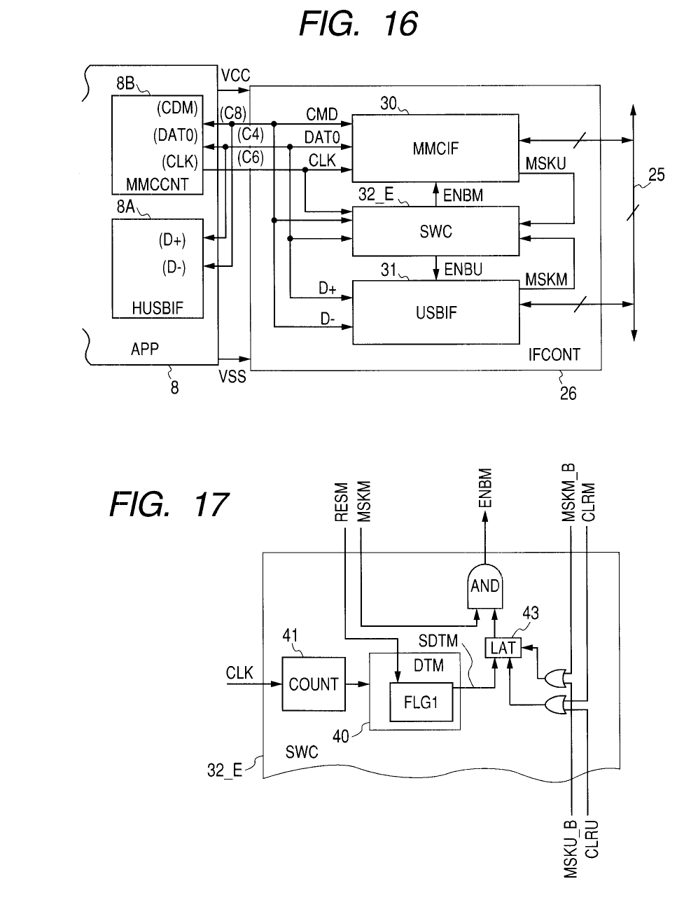

FIG. 15 shows an example of the configuration of another selection control circuit 32_D. Unlike the selection control circuit 32_C of FIG. 13, the selection control circuit 32_D includes latch circuits (LATs) 60, 61. The latch circuit 60 receives the signal RDTM at a data input terminal, and the latch circuit 61 receives the inverted signal of the signal RDTM at a data input terminal. The latch circuits 60, 61 perform latch operation by a logical sum signal of the inverted signal of the mask signal MSKM, and the inverted signal of the mask signal MSKU. This can prevent the defined state of the selection control of the interface operations exclusive to the MMCIF 30 and the USBIF 31, from being undesirably changed by noise. The latch circuits 60, 61 are initialized to a through state by a logical sum signal of the clear signal CLRM output from the MMCIF 30 in response to the reset instruction from the APP 8, and the clear signal CLRU output from the USBIF 31 in response to the reset instruction from the APP 8. Adoption of the latch circuits 60, 61 ensures resetting of the exclusive operation instruction to the MMCIOF 30 and the USBIF 31 by the reset instruction from the APP 8.

<Selection control of the interfaces based on the changes in CLK edge and in D+, D−> FIG. 16 shows still another example of the interface controller 26. In the figure, a selection control circuit 32_E enables/disables the MMCIF 30 by the use of the interface selection control method based on the edge changes in the CLK, which was described in the selection control circuit 32_A in FIG. 4. Also, the selection control circuit 32_E enables/disables the USBIF 31 by the use of the interface selection control method based on the changes in D+, D− at the time of VCC supply, which was described in FIG. 10.

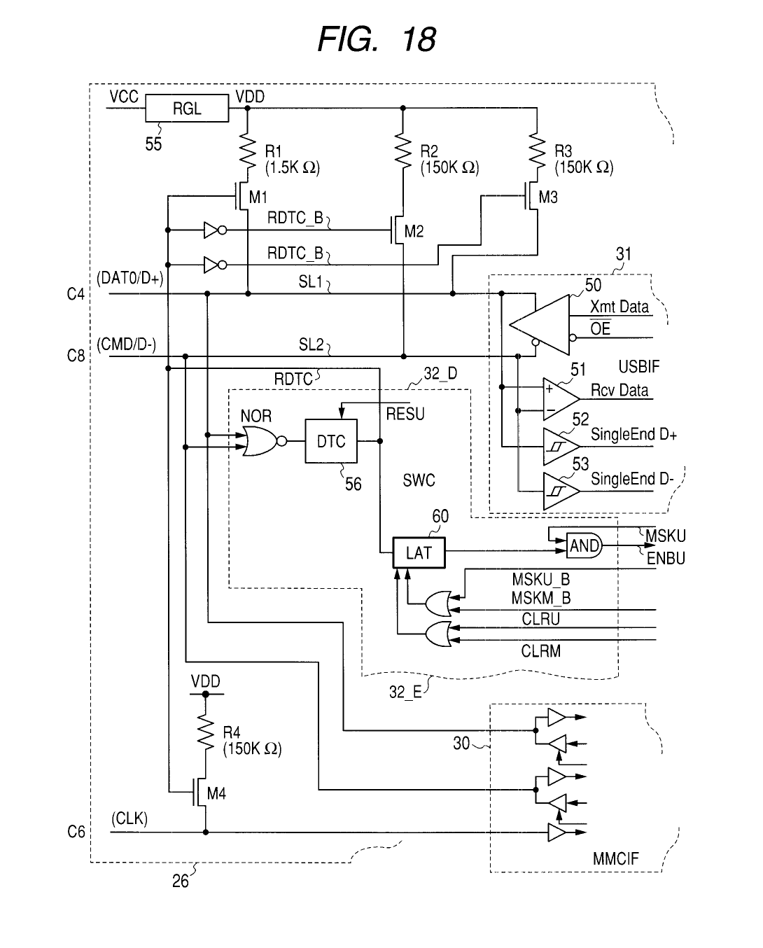

FIG. 17 shows an example of the configuration for controlling the enabling/disabling of the MMCIF 30 in the selection control circuit 32_E. The configuration of FIG. 17 has the same circuit configuration as that of FIG. 9, excluding the output stage of the enable signal ENBU and the latch circuit 44 relating to the USBIF 31. The same reference numerals are given to the circuit components having the same functions in FIG. 9, and the detailed description will be omitted. Although not shown in the figure, it is also possible to adopt a circuit configuration with the latch circuit 43A omitted in FIG. 17. FIG. 18 shows an example of the configuration for controlling the enabling/disabling of the USBIF 31 in the selection control circuit 32_E. The confirmation of FIG. 18 has the same circuit configuration as that of FIG. 15, excluding the output stage of the enable signal ENBM and the latch circuit 61 relating to the MMCIF 30. The same reference numerals are given to the circuit components having the same functions in FIG. 15, and the detailed description will be omitted. Although not shown in the figure, it is also possible to adopt a circuit configuration with the latch circuit 60A omitted in FIG. 18.

With the configuration of FIG. 16, as described above, when the MMCIF 30 is based on the MMC or SD card, the operation of the interface circuit MMCIF 30 can be selected without the need to change the interface function of the existing host apparatus based on the MMC or SD card. Further, when the USBIF 31 is based on USB, the operation of the interface circuit USBIF 31 can be selected without the need to change the interface function of the existing host apparatus based on USB. The control of the operation selection of the MMCIF 30 and the USBIF 31 is not completely exclusive. This means, for example, that the MFC 20 including the MMCIF 30 and the USBIF 31 in addition to the ICCM 21, can be used for interfacing with a host apparatus that is based only on the interface by the IC card microcomputer, with no difficulty. At this time, the interface operation is disabled both in the first and second interface circuits, thereby preventing malfunction and reducing wasteful power consumption.

In the MFC 20 according to all the embodiments described above, the external terminal that the ICCM 21 is coupled to is different from the external terminals that the MMCIF 30 and the USBIF 31 are coupled to. Thus, it is possible to operate the ICCM 21 and the MMCIF 30 in parallel, or the ICCM 21 and the USBIF 31 in parallel. For example, when the portable information terminal 1 is used for Internet communications based on TCPIP, it is possible to receive a specific approval by the ICCM 21, while in parallel downloading or uploading data by the large capacity flash memory 23, for example, through the USBIF 31.

The present invention made by the present inventor has been specifically described based on the embodiments. However, the present invention is not limited to the embodiments, and various modifications can be made within the scope of the present invention.

For example, the ICCMIF can be omitted. The semiconductor device according to the present invention is not limited to the card module such as MFC compatible with SIM. The present invention can be applied to a card module including a memory controller and ICCM, or to a memory card or memory module including an interface controller, a memory controller, and a flash memory. Further, the present invention can also be applied to a memory controller chip, a microcomputer chip including a memory controller and ICCM, and the like. The external terminals are not limited to the above described terminals C1 to C8. It is also possible to support an interface with an MMC or SD card having data terminals of a plurality of bits, by adding other data terminals. The latch circuits 43, 44 and 60, 61 can also be provided in the output stages of the enable signals ENBM and ENBU, respectively. Furthermore, the semiconductor device according to the present invention is not limited to the application to the portable communication terminal, but can also be applied to an ID card, a credit card, and the like.

1. A semiconductor device comprising:
a first interface circuit for interfacing signals using second external terminals, upon receiving a clock input from a first external terminal;
a second interface circuit for interfacing differential signals using the second external terminals, without receiving a clock input from the outside; and
a selection control circuit for detecting an input of a plurality of first clocks from the first external signal at the start of power supply, and outputting an activation signal of a first instruction signal to enable the interface operation of the first interface circuit.

2. The semiconductor device according to claim 1,
wherein the semiconductor device receives a command from the second external terminal when a plurality of second clocks are input to the first external terminal at the start of power supply, and
wherein the number of first clocks is a clock number in the midstream of reaching the number of second clocks.

3. The semiconductor device according to claim 2,
wherein, in response to the start of power supply, the selection control circuit initially disables the interface operation of the first interface circuit due to inactivation of the first instruction signal, and initially enables the interface operation of the second interface circuit due to activation of a second instruction signal output from the selection control circuit, and upon detection of the input of the first clocks, the selection control circuit disables the interface operation of the second interface circuit due to inactivation of the second instruction signal, and enables the interface operation of the first interface circuit due to activation of the first instruction signal.

4. The semiconductor device according to claim 3,
wherein the first interface circuit determines that the activation signal of the first instruction signal is in a defined state at a predetermined timing after the start of power supply, and outputs a first mask signal for fixing the state of the second instruction signal to a disable instruction state, and
wherein the second interface circuit determines that the activation signal of the second instruction signal is in a defined state at a predetermined timing after the start of power supply, and outputs a second mask signal for fixing the state of the first instruction signal to a disable instruction state.

5. The semiconductor device according to claim 4,
wherein, when the interface operation of the first interface circuit is enabled, the first interface circuit releases the disable instruction state to the second instruction signal in response to reset instructions supplied to the second external terminals, and
wherein, when the interface operation of the second interface circuit is enabled, the second interface circuit releases the disable instruction state to the first instruction signal in response to reset instructions supplied to the second external terminals.

6. The semiconductor device according to claim 4, further comprising a latch circuit for latching detection results obtained by a plurality of times of detecting the input of the clocks,
wherein the latch circuit performs latch operation due to the disable instruction state to the second instruction signal by the first mask signal, or due to the disable instruction state to the first instruction signal by the second mask signal.

7. The semiconductor device according to claim 6,
wherein, when the interface operations of the first and second interface circuits are enabled, the interface circuits initialize the latch circuit to a through state in response to the reset instructions supplied to the second external terminals.

8. The semiconductor device according to claim 1, further comprising:
a memory controller coupled to the first and second interface circuits by an internal bus; and
a non-volatile memory coupled to the memory controller.

9. The semiconductor device according to claim 8, further comprising a microcomputer coupled to third external terminals.

10. The semiconductor device according to claim 9,
wherein the first external terminal is defined as a clock terminal,
wherein the second external terminals are defined as a data terminal and a command terminal when used in the interface operation of the first interface circuit, and defined as a non-inverted data terminal and an inverted data terminal when used in the interface operation of the second interface circuit, and
wherein the third external terminals are defined as a reset terminal, a clock terminal, and an input/output terminal.

11. The semiconductor device according to claim 1,
wherein the first interface circuit is an MMC interface circuit or an SD card interface circuit, and
wherein the second interface circuit is a USB interface circuit.

12. A semiconductor device comprising:
a first interface circuit for interfacing signals using a pair of second external terminals, upon receiving a clock input from a first external terminal;
a second interface circuit for interfacing differential signals using the second external terminals, without receiving a clock input from the outside;
a first high-resistance DC circuit for initializing the second external terminals to a first level in response to the start of power supply;
a selection control circuit for enabling an interface operation of the second interface circuit by a first instruction signal, upon detection of a second level supplied to the initialized second external terminals; and
a second high-resistance DC circuit for changing the one of the second external terminals to a first level in response to the detection of the second level by the selection control circuit, so that the coupling of the second interface circuit can be recognized from the outside of the second external terminal.

13. The semiconductor device according to claim 12,
wherein, in response to the start of power supply, the selection control circuit initially disables the interface operation of the second interface circuit by the first instruction signal, and initially enables the interface operation of the first interface circuit by a second instruction signal output from the selection control circuit, and upon detection of the second level, the selection control circuit disables the interface operation of the first interface circuit, and enables the interface operation of the second interface circuit.

14. The semiconductor device according to claim 13,
wherein the first interface circuit determines that the instruction state by the second instruction signal is a defined state at a predetermined timing after the start of power supply, and outputs a first mask signal for fixing the state of the first instruction signal to a disable instruction state, and
wherein the second interface circuit determines that the instruction state by the first instruction signal is a defined state at a predetermined timing after the start of power supply, and outputs a second mask signal for fixing the state of the second instruction signal to a disable instruction state.

15. The semiconductor device according to claim 14,
wherein, when the interface operation of the first interface circuit is enabled, the first interface circuit releases the disable instruction state to the first instruction signal in response to reset instructions supplied to the second external terminals, and
wherein, when the interface operation of the second interface circuit is enabled, the second interface circuit releases the disable instruction state to the second instruction signal in response to reset instructions supplied to the second external terminals.

16. The semiconductor device according to claim 14, further comprising a latch circuit for latching the detection result obtained by detecting the second level, and
wherein the latch circuit performs latch operation due to the disable instruction state to the first instruction signal by the first mask signal, or due to the disable instruction state to the second instruction signal by the second mask signal.

17. The semiconductor device according to claim 15,
wherein, when the interface operations of the first and second interface circuits are enabled, the interface circuits initialize the latch circuit to a through state in response to the reset instructions supplied to the second external terminals.

18. The semiconductor device according to claim 12, further comprising:
a memory controller coupled to the first and second interface circuits by an internal bus; and
a non-volatile memory coupled to the memory controller.

19. The semiconductor device according to claim 18, further comprising a microcomputer coupled to third external terminals.

20. The semiconductor device according to claim 19,
wherein the first external terminal is defined as a clock terminal,
wherein the second external terminals are defined as a data terminal and a command terminal when used in the interface operation of the first interface circuit, and defined as a non-inverted data terminal and an inverted data terminal when used in the interface operation of the second interface circuit, and
wherein the third external terminals are defined as a reset terminal, a clock terminal, and an input/output terminal.

21. A semiconductor device comprising:
a first interface circuit for interfacing signals using a pair of second external terminals, upon receiving a clock input from a first external terminal;
a second interface circuit for interfacing differential signals using the second external terminals, without receiving a clock input from the outside;
a first high-resistance DC circuit for initializing the second external terminals to a first level in response to the start of power supply;
a selection control circuit for enabling, after start of power supply, an interface operation of the first interface circuit by a first instruction signal upon detection of a plurality of edge changes in the clock input from the first external terminal in order to initialize the first interface circuit, while enabling the interface operation of the second interface circuit by a second instruction signal upon detection of a second level supplied to the second external terminals that were initialized to the first level; and
a second high-resistance DC circuit for changing one of the second external terminals to the first level in response to the detection of the second level by the selection control circuit, so that the coupling of the second interface circuit can be recognized from the outside of the second external terminal.

22. The semiconductor device according to claim 21,
wherein the first interface circuit determines that the instruction state by the first instruction signal is a defined state at a predetermined timing after the start of power supply, and outputs a first mask signal for fixing the state of the second instruction signal to a disable instruction state, and
wherein the second interface circuit determines that the instruction state by the second instruction signal is a defined state at a predetermined timing after the start of power supply, and outputs a second mask signal for fixing the state of the first instruction signal to a disable instruction state.

23. The semiconductor device according to claim 22,
wherein, when the interface operation of the first interface circuit is enabled, the first interface circuit releases the disable instruction state to the second instruction signal in response to reset instructions supplied to the second external terminals, and
wherein, when the interface operation of the second interface circuit is enabled, the second interface circuit releases the disable instruction state to the first instruction signal in response to reset instructions supplied to the second external terminals.

24. The semiconductor device according to claim 22, further comprising:
a first latch circuit for latching the detection result obtained by a plurality times of detection; and
a second latch circuit for latching the detection result obtained by detecting the second level,
wherein the first and second latch circuits perform latch operation due to the disable instruction state to the second instruction signal by the first mask signal, or due to the disable instruction state to the first instruction signal by the second mask signal.

25. The semiconductor device according to claim 24,
wherein, when the interface operation of the first interface circuit is enabled, the first interface circuit initializes the first and second latch circuits to a through state in response to the reset instructions supplied to the second external terminals, and
wherein, when the interface operation of the second interface circuit is enabled, the second interface circuit initializes the first and second latch circuits to a through state in response to the reset instructions supplied to the second external terminals.

26. The semiconductor device according to claim 21, further comprising:
a memory controller coupled to the first and second interface circuits by an internal bus; and
a non-volatile memory coupled to the memory controller.

27. The semiconductor device according to claim 26, further comprising a microcomputer coupled to third external terminals.

28. The semiconductor device according to claim 27,
wherein the first external terminal is defined as a clock terminal,
wherein the second external terminals are defined as a data terminal and a command terminal when used in the interface operation of the first interface circuit, and defined as a non-inverted data terminal and an inverted data terminal when used in the interface operation of the second interface circuit, and
wherein the third external terminals are defined as a reset terminal, a clock terminal, and an input/output terminal.

29. The semiconductor device according to claim 2, further comprising:
a memory controller coupled to the first and second interface circuits by an internal bus; and
a non-volatile memory coupled to the memory controller.

30. The semiconductor device according to claim 29, further comprising a microcomputer coupled to third external terminals.

31. The semiconductor device according to claim 30,
wherein the first external terminal is defined as a clock terminal,
wherein the second external terminals are defined as a data terminal and a command terminal when used in the interface operation of the first interface circuit, and defined as a non-inverted data terminal and an inverted data terminal when used in the interface operation of the second interface circuit, and
wherein the third external terminals are defined as a reset terminal, a clock terminal, and an input/output terminal.

32. The semiconductor device according to claim 2,
wherein the first interface circuit is an MMC interface circuit or an SD card interface circuit, and
wherein the second interface circuit is a USB interface circuit.
